(19) United States
(12) Patent Application Publication
(10) Pub. No.: US 2007/0217146 A1
(43) Pub. Date: Sep. 20, 2007

(54) ATTACHMENT ASSEMBLY FOR MOUNTING ELECTRONIC DEVICES

(75) Inventors: Boguslaw BOZECKI, Zielona Gora (PL); Dariusz CICHONSKI, Zielona Gora (PL); Marek HOLUB-GORNY, Przylep (PL); Bartosz JANKOWSKI, Zielona Gora (PL); Jacek KAJMOWICZ, Sulechow (PL); Jaroslaw MICEWICZ, Wroclaw (PL)

Correspondence Address: MATTHIAS SCHOLL, 14781 MEMORIAL DRIVE, SUITE 1319, HOUSTON, TX, 77079, US

(73) Assignee: ADVANCED DIGITAL BROADCAST S.A., Grand-Saconnex (CH)

(21) Appl. No.: 11/687,004

(22) Filed: Mar. 16, 2007

(30) Foreign Application Priority Data
Mar. 17, 2006 (EP) 06461004.1

(51) Int. Cl. G06F 1/20; G06F 1/16

(52) U.S. Cl. 361/687; 361/685

(57) ABSTRACT

The present invention relates to an attachment assembly with a housing (105) for mounting at least one electronic device (110), and with at least one distance element (120) inserted between the housing (105) and the electronic device (110). The housing (105) comprises a casing (130) with stops (141) and a cover (160) whereas the distance element (120) is bracket-shaped and surrounds the electronic device (110) at three sides and is placed in a region adjacent to the stops (141).

### CROSS-REFERENCE TO RELATED APPLICATIONS

This application claims priority to the European Patent Application No. EP06461004.1, filed Mar. 17, 2006, the contents of which are incorporated herein by reference.

### BACKGROUND OF THE INVENTION

1. Field of the Invention

The object of the invention is an attachment assembly for mounting electronic devices, especially for mounting hard disks drives.

2. Brief Description of the Background of the Invention Including Prior Art

The increased level of complexity of home electronic appliances, such as television set-top boxes, digital video recorders, home media servers, DVD players or personal computers, calls for a careful design of those appliances, taking into account many factors important for their proper operation.

An important issue is an assembly of disk drives, such as optical disk drives or hard disk drives, to provide their proper operating conditions. There are several aspects that should be taken into account, namely isolation of vibrations, protection from mechanical shocks and cooling. The designs should be cost-effective both at manufacturing and assembly stages of the production process.

Disk drives operate at high rotational speeds, which cause vibrations of the drive. The vibrations, if not properly isolated, can be transferred to the housing of the appliance, which may result in a noise highly undesirable by the user. Home appliances are often displaced, for example during house cleaning works. If the displacement occurs during operation of the disk drive and results in a mechanical shock to the device, the disk drive may become damaged. Furthermore, disk drives, especially hard disk drives, emit large amounts of heat, which should be efficiently carried away from the drive.

There have been several attempts of providing a disk drive assembly of electronic devices, but none of them provided all of the aforementioned features.

The US patent application No. US 2005/0002122 entitled “Hard Disk Cartridge” presents a hard disk drive attachment assembly in which the hard disk is secured by means of a cushion member, which is attached to the hard disk by screws. The mounting screws is time consuming, which presents a considerable cost of the assembly stage of the production process.

The U.S. Pat. No. 6,570,759 entitled “Guide/elector device for computer” presents a hard disk drive attachment assembly utilizing two longitudinal guiding tracks of a shockproof rubbery material, which are to be attached to the sides of the hard disk. They have considerably large dimensions, which results in a considerable production cost. Moreover, since they cover the whole side surface of the hard disk, they limit the cooling efficiency.

The U.S. Pat. No. 6,882,528 entitled “Suspension-type shock-avoiding structure for a hard disk” presents a hard disk drive attachment assembly comprising a plurality of double-portion fasteners and shock absorbing members which hold the hard disk in position and isolate it from shocks. Due to a large number of components, such solution requires a lot of time to be mounted, which presents a considerable cost of the assembly stage of the production stage. Moreover, large number of elements results in a considerably high cost at the manufacturing stage.

The U.S. Pat. No. 6,496,362 entitled “Method and apparatus for protecting a hard disk drive from shock” presents a hard disk drive attachment assembly utilizing four resilient elements to be mounted at the corners of the hard disk. The elements are formed from two different materials, which make them relatively expensive to manufacture. Moreover, being mounted at the corners of the drive, they can be mounted only in a casing providing support at corners. This limits the freedom of casing design.

The U.S. Pat. No. 6,304,440 entitled “Shock-proof device of external hard disk drive box” presents a hard disk drive attachment assembly comprising a fixing block with a plurality of soft protecting pads. The fixing block is to be attached to the hard disk by means of screws. Such solution is neither inexpensive nor easy to mount.

The U.S. Pat. No. 6,873,524 entitled “Data storage device” presents a hard disk drive attachment assembly utilizing two types of shock-isolating pads. The pads of the first type are L-shaped, and 8 pads are necessary to secure the hard disk. This is both expensive and not easy to mount. The pads of the second type enclose the hard disk both from the top and from the bottom, but they are mounted at the corners, therefore 4 pads are necessary to secure the hard disk. Moreover, they can be mounted only in a casing providing support at all corners.

### SUMMARY OF THE INVENTION

### Purposes of the Invention

It is an object of the present invention to provide a cost-effective assembly of electronic devices, which would provide isolation of vibrations, protection from mechanical shocks and would not limit the design of the case, therefore enabling case design allowing efficient cooling.

This and other objects and advantages of the present invention will become apparent from the detailed description, which follows.

### Brief Description of the Invention

According to the invention, in an attachment assembly with a housing for mounting inside at least one electronic device, and with at least one distance element inserted between the housing and the electronic device, the housing consists of a casing with stops and a cover whereas the distance element is bracket-shaped and surrounds the electronic device at three sides and is placed in a region adjacent to the stops.

Preferably, the distance element has a top arm longer than a bottom arm to avoid interfere with the electronic circuits on a bottom side of the electronic device and to provide good holding conditions of the electronic device.

It is of special advantage that the distance element has a protrusion extending from a surface facing the electronic device and has a diameter adapted to be inserted in an opening situated in a side wall of the electronic device.

In a preferred embodiment, the distance element has a vertical wall with thickness g which is greater than a distance between a side wall of the casing and the electronic device and has height h, which is greater than a distance between a bottom surface of the cover and a surface of a stop extending perpendicularly from a side wall of the casing.

Preferably, a vertical axis of symmetry of the distance element and axis of symmetry of the first connecting elements are situated in one plane running perpendicularly to the side wall of the casing. It is advantageous that the casing and the cover has additional walls forming an air channel connected with an inside of the housing as well as that in the casing is mounted a fan causing flow of air stream from the outside of the housing to the electronic device.

Preferably, the casing is provided with first connecting elements and the cover is provided with second connecting elements adapted to be engaged with the first connecting elements wherein the first connecting elements and the second connecting elements are placed in a region adjacent to the placement of the distance elements.

The cover can have openings providing more efficient cooling of the electronic device.

Preferably, the distance element has a top arm which is rounded such as to provide easier airflow over a top surface of the electronic device.

### BRIEF DESCRIPTION OF THE DRAWINGS

The invention will now be described by way of example and with reference to the accompanying drawings in which:

FIG. 1 shows an exploded perspective view of a first embodiment of an attachment assembly;

FIG. 2 shows an enlarged top plan view of the attachment assembly shown in FIG. 1;

FIG. 3 shows an enlarged cross-section view of the attachment assembly taken according to line A-A shown in FIG. 2;

FIG. 4 shows an enlarged perspective view of a distance element;

FIG. 5 shows an enlarged side view of the distance element shown in FIG. 4;

FIG. 6 shows an exploded perspective view of a second embodiment of an attachment assembly; and

FIG. 7 shows a top plan view of a third embodiment of an attachment assembly.

### DESCRIPTION OF INVENTION AND PREFERRED EMBODIMENT

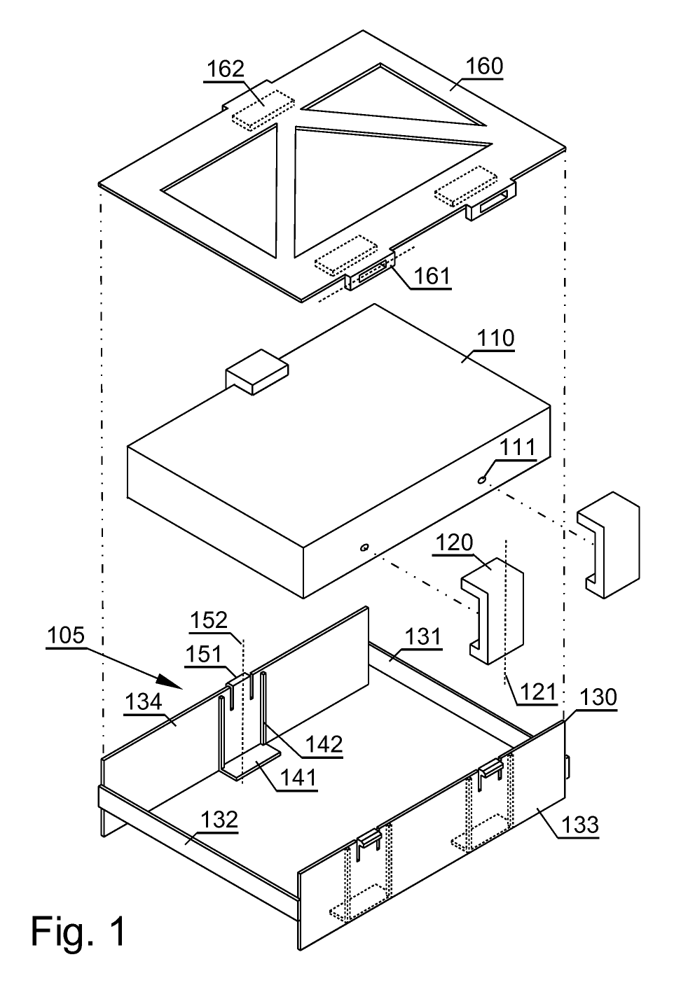

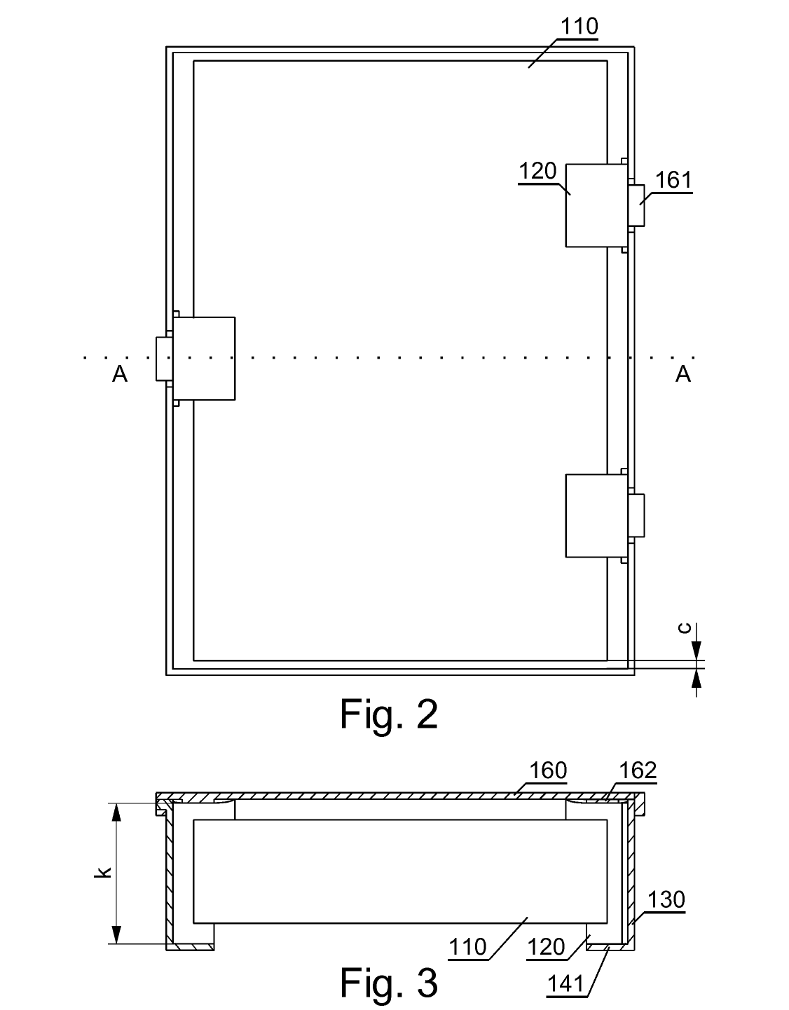

An attachment assembly 100, shown in FIGS. 1, 2 and 3, is one of embodiments of assemblies for mounting electronic devices especially for mounting hard disk drives according to the present invention. The attachment assembly comprises a housing 105 and distance elements 120. An inside of the housing 105 substantially matches in form the electronic device, for example a hard disk drive 110, to be placed in. The housing 105 is formed by a casing 130 with first connecting elements 151 and a cover 160 with second connecting elements 161. The distance elements 120 are bracket-shaped or have a form of distance brackets. Preferably, a vertical axis 121 of symmetry of the distance element 120 and an axis 152 of the first connecting elements are situated in one plane running perpendicularly to the side wall 133, 134 of the casing 130.

The casing 130 includes side walls 133, 134 provided at the bottom with stops 141, and side walls 131, 132. Before placing the electronic device in the casing 130, the distance brackets are attached to the hard disk 110 in places matching the stops 141. The casing 133 has additionally slide guides 142 adapted to receive the distance elements 120. In turn, the cover 160 has pads 162 or flat reinforcements in form of beads situated near the second connecting elements 161. The cover has also openings 165, which increase the efficiency of cooling of the hard disk.

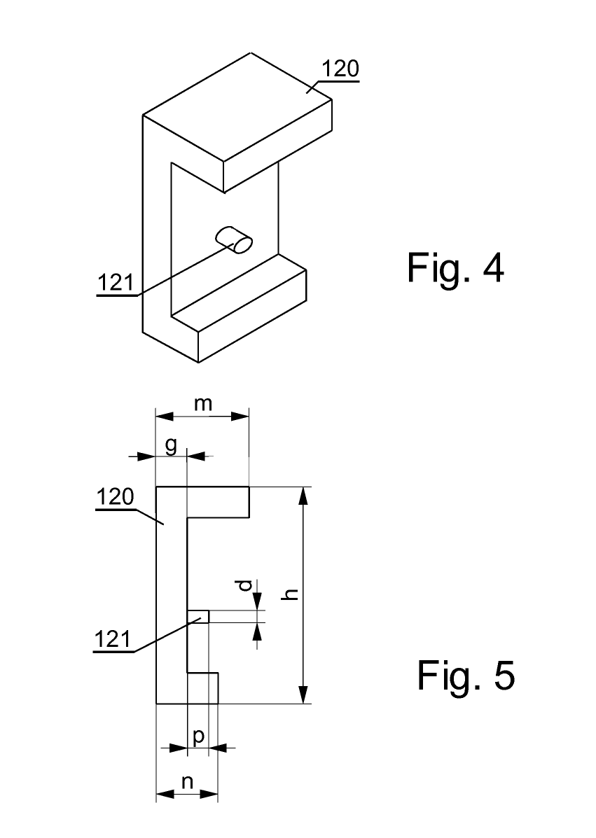

FIGS. 4 and 5 present the distance element 120 in details. The distance element 120 has a height h, which is shortened by the pads 162 of the cover 160 after the distance element is inserted in the casing 130 and the cover 160 is fastened. A vertical wall of the distance element has thickness g which is greater than a distance between the side wall 133, 134 of the casing 130 and the hard disk drive 110, and which is also shortened when the hard disk drive 110 is inserted together with the distance elements 120 into the casing 130. The distance element 120 has a top arm of length m and a bottom arm of length n. Preferably, the bottom arm is short, in order not to interfere with the electronic circuits on the bottom side of the hard disk. The top arm is long, in order to provide good holding conditions of the hard disk. For example, the bottom arm may have the length m of 1 cm and the top arm may have the length n of 1.5 cm. The distance element 120 has a protrusion 121 in a shape of a pin of a diameter d and a length p. The protrusion 121 is adapted to be inserted into a hard disk opening 111 for screws, thus providing additional holding force of the disk. The length of the protrusion p is greater than the distance c between the hard disk drive 110 and the side walls 131, 132 of the casing 130. When the housing is subject to a shock in the direction of the longer dimension of the hard disk, the displacement of the hard disk will be limited by the side walls 131, 132 to the distance c, thus preventing the slip-off of the protrusions 121 having length p greater than c.

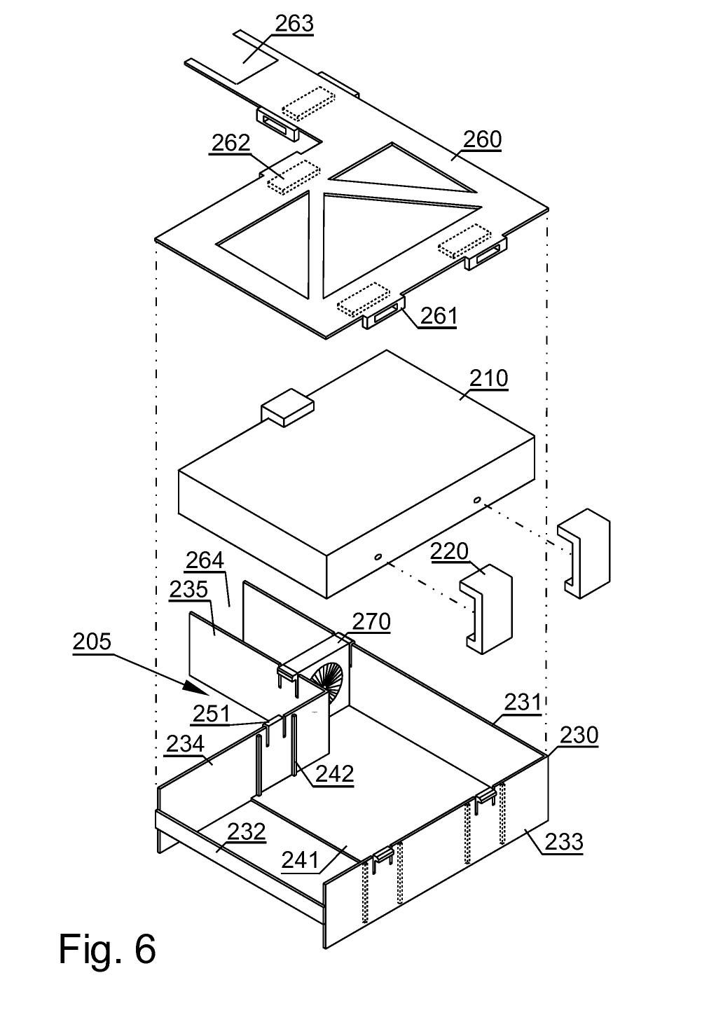

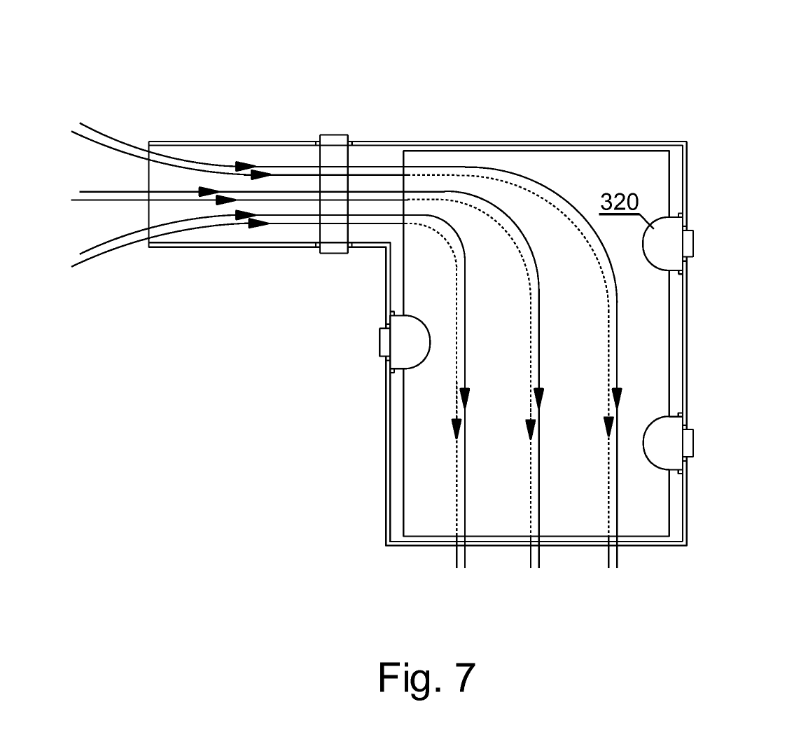

FIGS. 6 and 7 show second and third embodiments of attachment assemblies that differ in shape of the top arm of the distance elements 220, 320, namely the distance element 320 shown in FIG. 7 has the top arm which is rounded such as to provide easier airflow over a top surface of the electronic device. The housing of the attachment assembly shown in FIG. 6 consists of a casing 230 and a cover 260 with pads 262, connecting elements 261 and a top air intake 263. The casing 230 has a support plate 241 functioning as a stop for the distance elements 120, an elongated wall 231, side walls 233, 234 with connecting elements 251, a short wall 235 and a cross-bar 232. A part of the elongated wall 231 with adjacent to it the short wall 235 and a part of the support plate 241 form an air channel with a side air intake 264. In the air channel there is inserted a fan 270 which causes flow of air stream from the outside of the housing to both the top and bottom of the hard disk drive, as shown in details in FIG. 7. The air channel has two air intakes, namely the side air intake 264 and the top air intake 263. The housing may have apertures 242, 265 providing air flow outside the housing, which increases the cooling efficiency. The increase in cooling efficiency decreases the workload of the fan—it may operate for shorter periods or at lower speed. The top arm of the distance element 320 is rounded such as to provide easier airflow over the top surface of the electronic device.

The placement of the first connecting elements 151 along the symmetry axis of the stops 141 has the advantage that the distance elements 120, when inserted into the casing 130, provide a springing force to the first connecting elements 151, thus making the connection between the first connecting elements 151 and second connecting elements 161 more durable. However, if the material of the casing 130 is elastic enough, the first connecting elements 151 and the second connecting elements 161 can be placed at other positions of the casing.

The placement of pads 162 close to the second connecting elements 161 guarantees maximum force exerted by the pads on the distance elements 120. However, a design with second connecting elements 161 offset from the pads 162 would also provide some force exerted by the pads 162 on the distance elements 120, and thus would also be beneficial.

The embodiments presented have been described in relation to a hard disk drive, but the attachment assembly according to the invention can be used for mounting other electronic devices as well.

The distance elements thanks to their large surface can be made from the material that is soft enough, so they behave as shock and vibration absorbing elements when the disk operates. The distance elements prevent the hard disk drive before damage in case of drop of the appliance. The distance elements can is made of soft, elastic material, such as elastomeric material, silicone rubber, polyutherane or polyether-based polyutherane. The material can have compression characteristic around 35Sh.

The assembly of the hard disk drive is quicker than in case of screws. The cost of these elements is also smaller than the cost of common metal screws. The casing is made from plastic, such as ABS or other thermoplastic material, which considerably reduces the costs in comparison with the metal casing. Moreover, even in case of trembling transfer to the plastic, the hard disk drive works quieter than the hard disk drive mounted in a metal casing.

In addition, the disk is installed in the middle section of the casing, so the air is flowing at its upper and bottom surface, so the efficiency of cooling is improved. The present invention, therefore, is well adapted to carry out the objects and attain the ends and advantages mentioned. While the present invention has been depicted, described, and is defined by reference to particular preferred embodiments of the invention, such references in the foregoing specification do not imply a limitation on the invention. It will, however, be evident that various modifications and changes may be made thereto without departing from the broader scope of the invention. The presented preferred embodiments of the invention are exemplary only, and are not exhaustive of the scope of the invention. Consequently, the invention is intended to be limited only the spirit and scope of the appended claims.

The preferred embodiment having been thus described, it will now be evident to those skilled in the art that further variation thereto may be contemplated. Such variations are not regarded as a departure from the invention, the true scope of the invention being set forth in the claims appended hereto.

What is claimed is:

1. An attachment assembly for mounting electronic devices comprising:
a housing (105, 205) for mounting at least one electronic device (110, 210) and provided with a casing (130, 230) with stops (141, 241) and a cover (160, 260); at least one distance element (120, 220) inserted between the housing (105, 205) and the electronic device (110, 210) and placed in a region adjacent to the stops (141, 241) and having bracket-shape and surrounding the electronic device (110, 210) at three sides.

2. The attachment assembly according to claim 1, wherein the distance element (120) has a top arm longer than a bottom arm to avoid interfere with the electronic circuits on a bottom side of the electronic device (110, 210) and to provide good holding conditions of the electronic device (110, 210).

3. The attachment assembly according to claim 1, wherein the distance element (120) has a protrusion (121) extending from a surface facing the electronic device (110, 210) and has a diameter adapted to be inserted in an opening (111) situated in a side wall of the electronic device (110, 210).

4. The attachment assembly according to claim 1, wherein the distance element (120) has a vertical wall with thickness g which is greater than a distance between a side wall (133, 134) of the casing (130) and the electronic device (110).

5. The attachment assembly according to claim 1, wherein the distance element (120) has height h, which is greater than a distance between a bottom surface of the cover and a surface of a stop (141, 241) extending perpendicularly from a side wall (133, 134) of the casing (130).

6. The attachment assembly according to claim 1, wherein a vertical axis (121) of symmetry of the distance element (120) and an axis (152) of the first connecting elements (151) are situated in one plane running perpendicularly to the side wall (133, 134) of the casing (130).

7. The attachment assembly according to claim 1, wherein the casing (130) and the cover (160) has additional walls forming an air channel (264) connected with an inside of the housing (205).

8. The attachment assembly according to claim 1, wherein in the casing (130) is mounted a fan (270) and the cover (160) has additional walls forming an air channel (264) causing flow of air stream from the outside of the housing (205) to the electronic device (210).

9. The attachment assembly according to claim 1, wherein the casing (130, 230) is provided with first connecting elements (151, 251) and the cover (160, 260) is provided with second connecting elements (161, 261) adapted to be engaged with the first connecting elements (151, 251) wherein the first connecting elements (151, 251) and the second connecting elements (161, 261) are placed in a region adjacent to the placement of the distance elements (120, 220).

10. The attachment assembly according to claim 1, wherein the distance element (320) has a top arm which is rounded such as to provide easier airflow over a top surface of the electronic device (110, 210).

11. The attachment assembly according to claim 1, wherein the cover (160, 260) has openings (165, 265) providing more efficient cooling of the electronic device.
